(19) United States
(12) Patent Application Publication
(10) Pub. No.: US 2019/0362517 A1
(43) Pub. Date: Nov. 28, 2019

(54) IMAGE DATABASE CREATION DEVICE, LOCATION AND INCLINATION ESTIMATION DEVICE, AND IMAGE DATABASE CREATION METHOD

(71) Applicant: Mitsubishi Electric Corporation, Tokyo (JP)

(72) Inventor: Ken MIYAMOTO, Tokyo (JP)

(73) Assignee: Mitsubishi Electric Corporation, Tokyo (JP)

(21) Appl. No.: 16/474,243

(22) PCT Filed: Feb. 16, 2017
(86) PCT No.: PCT/JP2017/005709

§ 371 Date: Jun. 27, 2019

(51) Int. Cl. G06T 7/70; H04W 64/00; H04W 4/02; H04W 4/33

(52) U.S. Cl. CPC G06T 7/70; H04W 4/33; H04W 4/025; H04W 64/003

(57) ABSTRACT

An area detection unit detects which area out of a plurality of areas a photographed image belongs to. A sensor information acquiring unit acquires the photographed image and distance information. A locational relationship calculating unit calculates the acquisition location and inclination of each photographed image on the basis of the photographed image and the distance information acquired by the sensor information acquiring unit. An image database generating unit generates an image database by associating the photographing location and the inclination of the photographed image and the photographed image as image information and grouping image information of images belonging to the same area.

### TECHNICAL FIELD

The present invention relates to an image database creation device for generating an image database for estimation of the location of a terminal indoors, a location and inclination estimation device for estimating the location of the terminal using the image database, and an image database creation method.

### BACKGROUND ART

For example in a case of development of an application using augmented reality (AR) in which additional information is displayed while superimposed on a specific object, mere location information of the terminal is insufficient, and information of the inclination of the terminal is necessary. Moreover, in such an application, it is necessary to estimate an accurate location as the location information of the terminal.

In the related art, as a method of obtaining an accurate location and inclination of a terminal, there is a method of using images registered in advance (e.g. see Non-Patent Literature 1). This is to link all indoor images and location and inclination information to obtain image data and to accumulate this image data to prepare a database. When the location of the terminal is to be estimated, an image photographed from the terminal location is collated with all the images in the database, thereby searching the most similar image, and the location and inclination of the image are output.

### CITATION LIST

### Non-Patent Literatures

Non-Patent Literature 1: Esra Ataer-Cansizoglu, Yuichi Taguchi, Srikumar Ramlingam, and Yohei Miki: Calibration of Non-Overlapping Cameras Using an External SLAM System, Image Processing (ICIP), 2016 IEEE International Conference on 25-28 Sep. 2016

### SUMMARY OF INVENTION

### Technical Problem

However, in the method of estimating the location and inclination of the related art, there is a disadvantage such as the following since collation with an image similar to the photographed image is made for all the indoor images. That is, as a first disadvantage, the real-time property is deteriorated. This is because, as the number of pieces of image data stored in the database increases, the calculation cost increases, which deteriorates the real-time property. As a second disadvantage, it is difficult to discriminate the same scenes. For example, there is a possibility that an incorrect collation result is obtained in a case where similar scenes at different locations are stored in the database, that is, image data, in which shapes of subjects are similar, although being at different locations is stored in the database.

Note that, as a means to obtain the location of the terminal, it is also conceivable to use a satellite positioning system such as the global positioning system (GPS). However, indoor positioning is difficult using such a satellite positioning system, and the positioning accuracy for obtaining the accurate location of the terminal is insufficient. Therefore, it is difficult to apply to a device for estimating the indoor location and the inclination. In particular, in a case where similar pieces of image data exist on multiple floors such as in a building, since the positioning accuracy in the height direction is insufficient in a method using a satellite positioning system, accurate collation results cannot be obtained, and thus also from this point, it is difficult to estimate the location and inclination of the indoor terminal using a satellite positioning system.

The present invention has been devised in order to solve such disadvantages, and an object of the invention is to provide an image database creation device and an image database creation device capable of improving the real-time property and providing an accurate estimation result of location and inclination.

### Solution to Problem

An image database creation device according to the present invention includes: an area detection unit for detecting which area out of a plurality of areas a photographed image belongs to; an information acquiring unit for acquiring distance information indicating a distance between a photographed object of the photographed image and an acquisition location of the photographed image; a calculating unit for calculating a photographing location and an inclination of the photographed image on the basis of the distance information; and an image database generating unit for generating an image database in which the photographing location and the inclination of the photographed image and the photographed image are associated as image information, the image database generating unit generating the image database by grouping image information of images belonging to a same area.

In addition, a location and inclination estimation device according to the present invention includes: an image database for storing image information in which images each having information of a photographing location and an inclination are grouped by a plurality of areas; an area detection unit for detecting which area out of the plurality of areas an image belong to; an image acquiring unit for acquiring an image of a photographed object; a database collating unit for collating the image acquired by the image acquiring unit with only images belonging to a same area detected by the area detection unit out of the images stored in the image database; and a location and inclination estimating unit for outputting, as an estimation result, a location and an inclination of an image as a result of the collation in the database collating unit.

### Advantageous Effects of Invention

An image database creation device according to the present invention associates a photographed image, the acquisition location and the inclination of the photographed image, and area information and generates an image database by using the associated image information. As a result, it is possible to provide the image database capable of improving the real-time property for estimation of location and inclination of an image and providing an accurate estimation result of the location and inclination.

Moreover, a location and inclination estimation device according to the present invention collates with only images belonging to the same area as an area detected by an area detection unit out of the images stored in the image database. As a result, the real-time property can be improved, and an accurate estimation result of location and inclination can be obtained.

### BRIEF DESCRIPTION OF DRAWINGS

FIG. 1 is a configuration diagram of an image database creation device according to a first embodiment of the present invention.

FIG. 2 is a hardware configuration diagram of the image database creation device according to the first embodiment of the present invention.

FIG. 3 is an explanatory diagram of rooms to which the image database creation device of the first embodiment of the present invention is applied.

FIG. 4 is a flowchart illustrating the operation of the image database creation device according to the first embodiment of the present invention.

FIG. 5 is an explanatory diagram illustrating an example of an image database generated in the image database creation device according to the first embodiment of the present invention.

FIG. 6 is an explanatory diagram of a conventional image database.

FIG. 7 is a configuration diagram of a location and inclination estimation device according to the first embodiment of the present invention.

FIG. 8 is a hardware configuration diagram of the location and inclination estimation device according to the first embodiment of the present invention.

FIG. 9 is a flowchart illustrating the operation of the location and inclination estimation device of the first embodiment of the invention.

FIG. 10 is a configuration diagram of an image database creation device according to a second embodiment of the present invention.

FIG. 11 is a hardware configuration diagram of the image database creation device according to the second embodiment of the present invention.

FIG. 12 is an explanatory diagram of rooms to which the image database creation device of the second embodiment of the present invention is applied.

FIG. 13 is a flowchart illustrating the operation of the image database creation device according to the second embodiment of the present invention.

FIG. 14 is an explanatory diagram illustrating an example of an image database generated in the image database creation device according to the second embodiment of the present invention.

FIG. 15 is a configuration diagram of a location and inclination estimation device according to the second embodiment of the present invention.

FIG. 16 is a hardware configuration diagram of the location and inclination estimation device according to the second embodiment of the present invention.

FIG. 17 is a flowchart illustrating the operation of the location and inclination estimation device of the second embodiment of the invention.

### DESCRIPTION OF EMBODIMENTS

To describe the invention further in detail, embodiments for carrying out the invention will be described below with reference to the accompanying drawings.

### First Embodiment

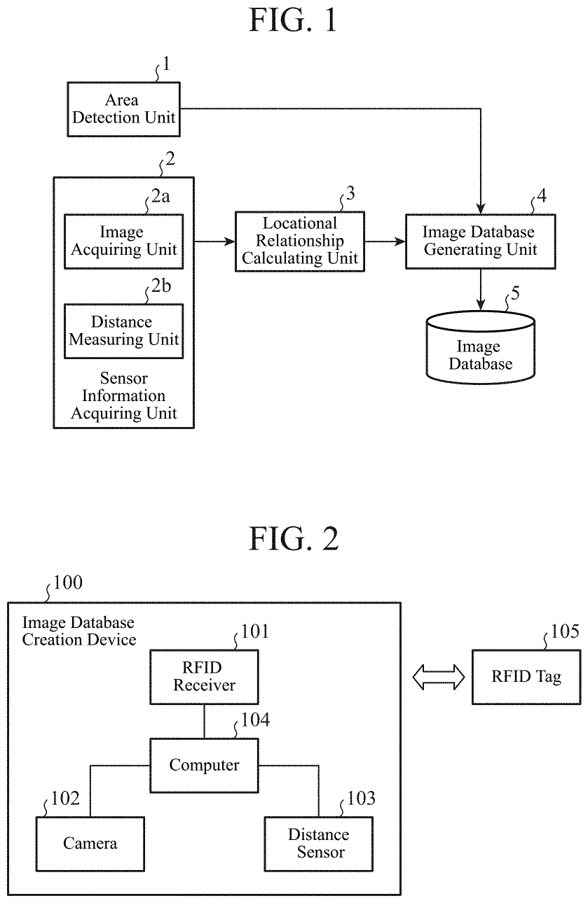

FIG. 1 is a configuration diagram of an image database creation device according to the present embodiment.

The illustrated image database creation device includes an area detection unit 1, a sensor information acquiring unit 2, a locational relationship calculating unit 3, and an image database generating unit 4. The area detection unit 1 is a processing unit that detects, as area information, in which area out of a plurality of indoor areas the location is. The sensor information acquiring unit 2 includes an image acquiring unit 2a and a distance measuring unit 2b. The image acquiring unit 2a is a device for acquiring an indoor image, and the distance measuring unit 2b is a processing unit for measuring distance information indicating a distance between a photographed object in a photographed image and the acquisition location of the photographed image. The locational relationship calculating unit 3 calculates the acquisition location and the inclination of each photographed image on the basis of the photographed image and the distance information acquired by the sensor information acquiring unit 2. The image database generating unit 4 is a processing unit for associating the acquisition location and the inclination of the photographed image calculated by the locational relationship calculating unit 3, the photographed image acquired by the sensor information acquiring unit 2, and the area information detected by the area detection unit 1 to obtain image information and generating an image database 5 by using the image information.

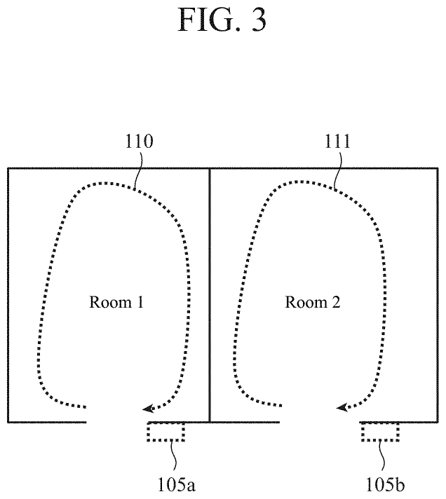

FIG. 2 is a hardware configuration diagram of the image database creation device illustrated in FIG. 1. In FIG. 2, the image database creation device 100 includes a radio frequency identification (RFID) receiver 101, a camera 102, a distance sensor 103, and a computer 104. The RFID receiver 101 communicates with RFID tags 105 provided to each of the plurality of indoor areas and detects which RFID tag 105 has been recognized. The camera 102 is a device for acquiring a color image. The distance sensor 103 is a device for acquiring a distance image (an image obtained by imaging the distance corresponding to each pixel). The computer 104 is a device for acquiring data from the RFID receiver 101, the camera 102, and the distance sensor 103 and generating the image database 5 of FIG. 1 on the basis of these pieces of data, and includes, for example, a personal computer or a smartphone.

The RFID receiver 101 in FIG. 2 implements the area detection unit 1 in FIG. 1, the camera 102 implements the image acquiring unit 2a, and the distance sensor 103 implements the distance measuring unit 2b. The computer 104 implements the functions of the locational relationship calculating unit 3 and the image database generating unit 4. These functions are implemented by a processor of the computer 104 executing software corresponding to the locational relationship calculating unit 3 and the image database generating unit 4.

In the case where the image database creation device in FIG. 1 is configured as illustrated in FIG. 2, the area detection unit 1 to the image database generating unit 4 in FIG. 1 have the following functions. The area detection unit 1 communicates with an RFID tag 105 to recognize an attribute thereof (as to being in which area). The sensor information acquiring unit 2 acquires pairs of a plurality of color images and distance information corresponding to these color images. The locational relationship calculating unit 3 combines the information acquired by the sensor information acquiring unit 2 to create three-dimensional point group data and estimates the acquisition location and the inclination of each of the pairs of a color image and distance information. The image database generating unit 4 associates, as image information, the acquisition location and the inclination of the photographed image estimated by the locational relationship calculating unit 3, the photographed image, and the area information and generates the image database 5 by using the image information.

Next, the operation of the image database creation device of the first embodiment will be described.

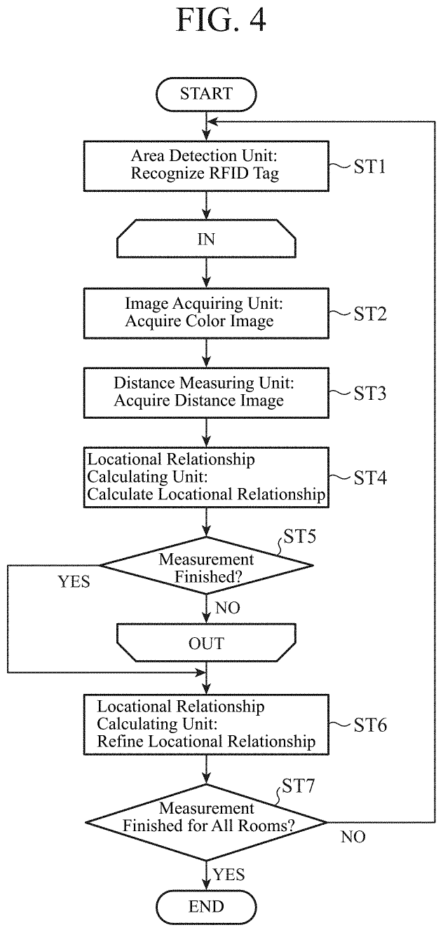

FIG. 3 is a diagram illustrating two rooms when viewed from above. Each of the rooms (room 1 and room 2) corresponds to each area, and a first RFID tag 105a and a second RFID tag 105b are provided near the entrance of each of the rooms. The operation to configure an image database for such two rooms will be described with reference to a flowchart of FIG. 4.

First, description is given with the assumption that data of room 1 in FIG. 3 is acquired as indicated by a dotted line 110. The area detection unit 1 recognizes the first RFID tag 105a (area detecting step: step ST1). Then the image acquiring unit 2a of the sensor information acquiring unit 2 acquires color images of room 1 (information acquiring step: step ST2), and the distance measuring unit 2b acquires distance images (information acquiring step: step ST3). Next, the locational relationship calculating unit 3 connects the data acquired by the sensor information acquiring unit 2 and calculates the location and inclination of the device for acquiring the color images and measuring the distance images (calculating step: step ST4). An example of the location and inclination obtained here is a value with reference to the location and inclination at the start time of the measurement. As an example of a method of connecting pairs of color images and distance information, there is a method using points that are characteristic of the images (for example, a method described in: Taguchi, Y, Jian, Y-D, Ramlingam, S: Point-Plane SLAM for Hand-Held 3D Sensors, Robotics and Automation (ICRA), 2014 IEEE International Conference on 6-10 May 2013). After the processing of steps ST2 to ST4 has been performed on one room, the measurement is finished (step ST5: YES). The locational relationship calculating unit 3 further refines the location and inclination of the sensor using bundle adjustment and the like (step ST6). Thereafter, it is determined whether measurement of all the rooms has been completed (step ST7), and if not completed, the flow returns to step ST1 to repeat the above processing. If measurement of all the rooms has been completed, the operation of configuring the image database is finished. In this case, since measurement of room 2 has not yet performed, “NO” is obtained in step ST7, and a color image and distance information are acquired at each location as indicated by a dotted line 111 in FIG. 3 to perform the processing of steps ST2 to ST6.

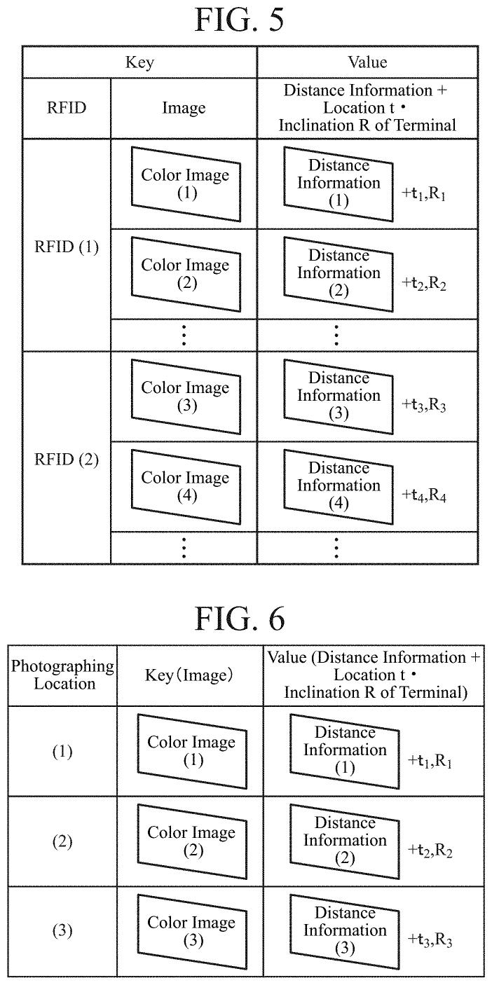

When measurement is performed for room 1 and room 2 by such a method, a database illustrated in FIG. 5 is generated by the image database generating unit 4 (image database generating step). As illustrated in FIG. 5, pairs of an image, anddistance information/the location and inclination are registered for each RFID. A database of the related art is illustrated in FIG. 6 for comparison. As compared to the database of FIG. 6, in the database by the image database creation device of the present embodiment, images are grouped for each RFID.

Next, a location and inclination estimation device of the first embodiment will be described.

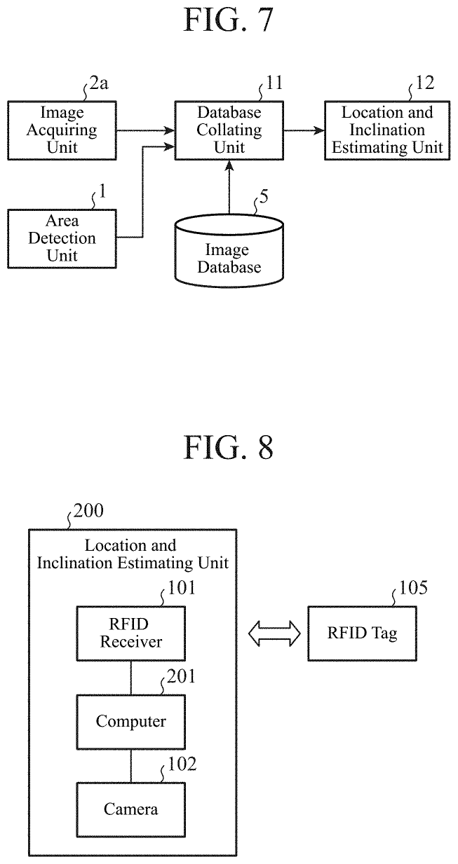

FIG. 7 is a configuration diagram of a location and inclination estimation device. The location and inclination estimation device of the present embodiment includes an area detection unit 1, an image acquiring unit 2a, a database collating unit 11, and a location and inclination estimating unit 12. The area detection unit 1 and the image acquiring unit 2a are similar to the area detection unit 1 and the image acquiring unit 2a in the image database creation device; however, they are included in a terminal to be a estimate target by the location and inclination estimation device. The database collating unit 11 is a processing unit for collating the image acquired by the image acquiring unit 2a with only images having the same area information as the area information detected by the area detection unit 1 out of the images stored in the image database 5 and specifying one of the images. The location and inclination estimating unit 12 is a processing unit for outputting the location and inclination of the image specified by the database collating unit 11 as an estimation result. The image database 5 is generated by the image database creation device.

FIG. 8 is a hardware configuration diagram of the location and inclination estimation device illustrated in FIG. 7. In FIG. 8, a location and inclination estimation device 200 includes an RFID receiver 101, a camera 102, and a computer 201. The RFID receiver 101 and the camera 102 are similar to the RFID receiver 101 and the camera 102 in the image database creation device 100. The computer 201 is a device for acquiring data from the RFID receiver 101 and the camera 102 and estimating the location and inclination of the terminal on the basis of these pieces of data, and includes, for example, a personal computer or a smartphone.

The RFID receiver 101 in FIG. 8 implements the area detection unit 1 in FIG. 7, and the camera 102 implements the image acquiring unit 2a. The computer 201 implements the functions of the database collating unit 11 and the location and inclination estimating unit 12. These functions are implemented by a processor of the computer 201 executing software corresponding to the database collating unit 11 and the location and inclination estimating unit 12.

In the case where the location and inclination estimation device in FIG. 7 is configured as illustrated in FIG. 8, the area detection unit 1 to the location and inclination estimating unit 12 in FIG. 7 have the following functions. The area detection unit 1 communicates with an RFID tag 105 to recognize an attribute thereof (as to being in which area). The image acquiring unit 2a acquires a color image photographed from the terminal location. The database collating unit 11 collates with the image database 5 on the basis of the color image acquired by the image acquiring unit 2a and the area information detected by the area detection unit 1, and the location and inclination estimating unit 12 outputs, as an estimation result, the location and inclination of an image as a collation result in the database collating unit 11.

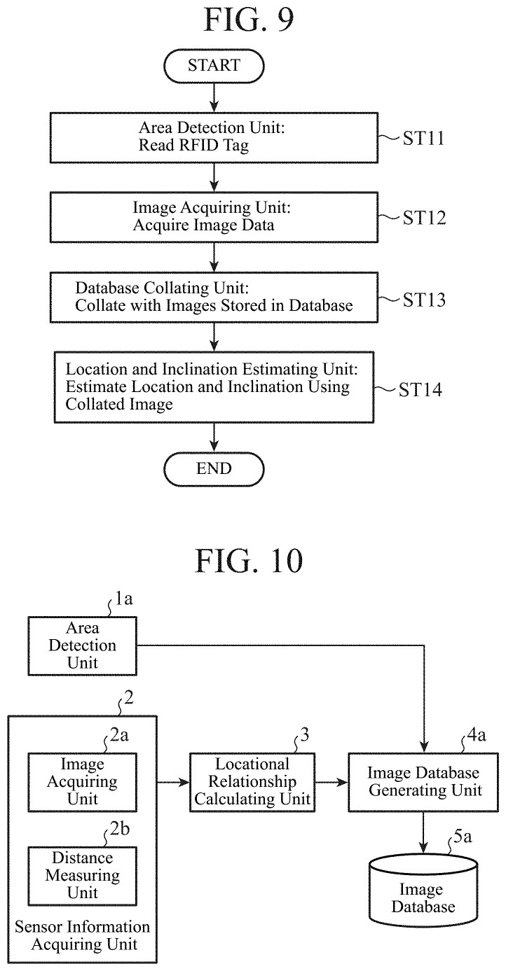

Next, the operation of the location and inclination estimation device according to the first embodiment will be described with reference to a flowchart of FIG. 9.

A user brings the RFID tag 105 into contact with the RFID receiver 101 to make it read the RFID tag 105 (step ST11) to input information of the room in which the terminal is located. Note that this input may be manually performed by the user to the RFID receiver 101 (database collating unit 11), or information of the RFID tag 105 from the RFID receiver 101 may be directly given to the RFID receiver 101 (database collating unit 11) as information of the room. Note that in this example it is assumed that the terminal has entered room 1 of the first RFID tag 105a illustrated in FIG. 3. In such a state, when the image acquiring unit 2a acquires image data in room 1 (step ST12), the database collating unit 11 collates with the data in the image database 5 (step ST13). In this example, in the image database illustrated in FIG. 5, collation is performed only with images of RFID (1). Then, from the color images of the RFID (1), an image most similar to the image acquired in step ST12 is extracted. Next, the location and inclination estimating unit 12 estimates the location and inclination of the terminal on the basis of the distance information of the terminal+location t and inclination R of the terminal attached to the image extracted in step ST13 (step ST14).

In this manner, according to the location and inclination estimation device of the first embodiment, as a first effect, calculation time is reduced. In the present embodiment, the collation with the image database 5 is performed only on image data that corresponds to a specified area. Therefore, the number of images to be collated can be reduced as compared with the related art. For example, in the above example, the collation is performed only with the images of RFID (1) and not with images of RFID (2), and thus the calculation time can be reduced. As a second effect, discrimination of similar scenes is improved. For example, even in a case where room 1 and room 2 illustrated in FIG. 3 have the interior of similar patterns, since the collation is made while room 1 and room 2 are discriminated, the terminal location can be estimated accurately.

Note that in the image database creation device and the location and inclination estimation device, the RFID is used as the means to specify the areas; however, any means capable of uniquely specifying the areas, such as a beacon, can be used likewise.

As described above, according to the image database creation device of the first embodiment, included are: the area detection unit for detecting which area out of a plurality of areas a photographed image belongs to; the information acquiring unit for acquiring distance information indicating a distance between a photographed object of the photographed image and an acquisition location of the photographed image; the calculating unit for calculating a photographing location and an inclination of the photographed image on the basis of the distance information; and the image database generating unit for generating an image database in which the photographing location and the inclination of the photographed image and the photographed image are associated as image information, the image database generating unit generating the image database by grouping image information of images belonging to the same area. Therefore, it is possible to provide the image database capable of improving the real-time property for estimation of location and inclination of an image and providing an accurate estimation result of the location and inclination.

Moreover, according to the image database creation device of the first embodiment, the plurality of areas are associated with the areas detected by the area detection unit in a one-on-one manner, and thus the areas can be specified easily and reliably.

Moreover, according to the image database creation device of the first embodiment, the area detection unit detects an area using the RFID, and thus the areas can be specified easily and reliably.

In addition, according to the location and inclination estimation device of the first embodiment, included are: the image database for storing image information in which images each having information of a photographing location and an inclination are grouped by a plurality of areas; the area detection unit for detecting which area out of the plurality of areas an image belong to; the image acquiring unit for acquiring an image of a photographed object; the database collating unit for collating the image acquired by the image acquiring unit with only images belonging to the same area detected by the area detection unit out of the images stored in the image database; and the location and inclination estimating unit for outputting, as an estimation result, a location and an inclination of an image as a result of the collation in the database collating unit. Therefore, it is possible to improve the real-time property and to obtain an accurate estimation result of the location and inclination.

Moreover, according to the location and inclination estimation device of the first embodiment, the plurality of areas are associated with the areas detected by the area detection unit in a one-on-one manner, and thus the areas can be specified easily and reliably.

Moreover, according to the location and inclination estimation device of the first embodiment, the area detection unit detects an area using the RFID, and thus the areas can be specified easily and reliably.

In addition, according to the image database creation method of the first embodiment, since the image database creation method using the image database creation device according to the first embodiment includes: an area detecting step of detecting which area out of a plurality of areas a photographed image belongs to; an information acquiring step of acquiring distance information indicating a distance between a photographed object of the photographed image and an acquisition location of the photographed image; a calculating step of calculating a photographing location and an inclination of the photographed image on the basis of the distance information; and an image database generating step of generating an image database in which the photographing location and the inclination of the photographed image and the photographed image are associated as image information, the image database generating step generating the image database by grouping image information of images belonging to the same area, it is possible to provide the image database capable of improving the real-time property for estimation of location and inclination of an image and providing an accurate estimation result of the location and inclination.

### Second Embodiment

A second embodiment includes an image database creation device for generating an image database by grouping on the basis of values of signals obtained at a plurality of indoor locations and a location and inclination estimation device for estimating the location and inclination using the image database configured by the image database creation device.

FIG. 10 is a configuration diagram of an image database creation device according to the second embodiment. The illustrated image database creation device includes an area detection unit 1a, a sensor information acquiring unit 2, a locational relationship calculating unit 3, and an image database generating unit 4a. In this embodiment, since the sensor information acquiring unit 2 and the locational relationship calculating unit 3 are similar components to those in the first embodiment, description thereof is omitted here. The area detection unit 1a is a processing unit for measuring set signal values at a plurality of indoor locations as values corresponding to areas. The image database generating unit 4a groups calculation information of the location and inclination of each photographed image calculated by the locational relationship calculating unit 3 using the signal values measured by the area detection unit 1a, associates the grouped photographed images, the acquisition location and inclination of the photographed images, and the signal values, and generates an image database 5a by using the associated image information.

FIG. 11 is a hardware configuration diagram of the image database creation device illustrated in FIG. 10. In FIG. 11, an image database creation device 100a includes a wireless LAN receiver 106, a camera 102, a distance sensor 103, and a computer 104a. The wireless LAN receiver 106 communicates with an access point 107 of a wireless LAN provided in each of a plurality of indoor areas and measures the signal strength (received signal strength indicator (RSSI)) thereof. The camera 102 and the distance sensor 103 are similar to the camera 102 and the distance sensor 103 in the image database creation device 100 of the first embodiment. The computer 104a is a device for acquiring data from the wireless LAN receiver 106, the camera 102, and the distance sensor 103 and generating the image database 5a of FIG. 10 on the basis of these pieces of data, and includes, for example, a personal computer or a smartphone.

The wireless LAN receiver 106 in FIG. 11 implements the area detection unit la in FIG. 10, the camera 102 implements an image acquiring unit 2a, and the distance sensor 103 implements a distance measuring unit 2b. The computer 104a implements the functions of the locational relationship calculating unit 3 and the image database generating unit 4a. These functions are implemented by a processor of the computer 104a executing software corresponding to the locational relationship calculating unit 3 and the image database generating unit 4a.

Next, the operation of the image database creation device of the second embodiment will be described.

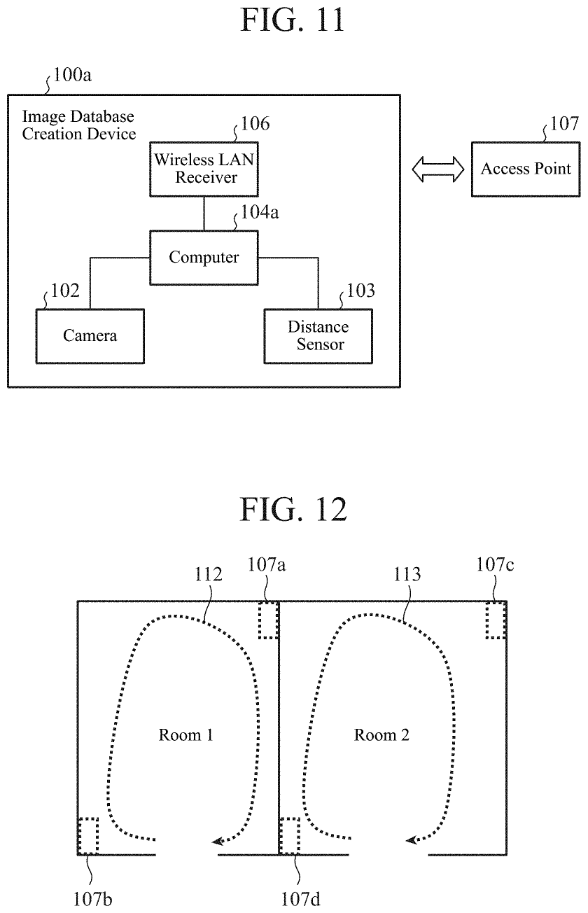

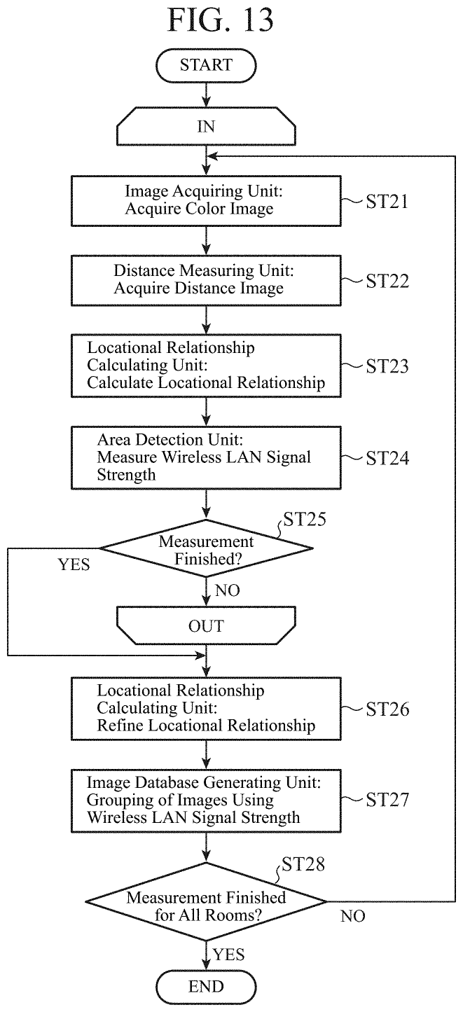

FIG. 12 is a diagram illustrating two rooms when viewed from above. An access point 107a and an access point 107b are installed in room 1, and an access point 107c and an access point 107d are installed in room 2. The operation of configuring an image database of such two rooms will be described with reference to a flowchart of FIG. 13.

First, description is given with the assumption that data of room 1 in FIG. 12 is acquired as indicated by a dotted line 112. In the flowchart of FIG. 13, since steps ST21 to ST23 are similar to steps ST2 to ST4 in FIG. 4 of the first embodiment, description thereof is omitted here. In the second embodiment, the area detection unit la communicates with the access points 107 at a plurality of locations in room 1 and measures the signal strength (RSSI) from the access points 107 (area detecting step: step ST24). As a result, at each location, the signal strength corresponding to one of the access points 107a to 107d at that location can be obtained. After the processing of steps ST21 to ST24 has been performed on one room, the measurement is finished (step ST25: YES). The locational relationship calculating unit 3 further refines the location and inclination of a sensor using bundle adjustment and the like (step ST26). Next, the image database generating unit 4a performs grouping of color images and distance information on the basis of the signal strength obtained in step ST24 (image database generating step: step ST27). As an example of grouping method, there are unsupervised learning methods such as K-means clustering and spectral clustering.

Thereafter, it is determined whether measurement of all the rooms has been completed (step ST28), and if not completed, the processing from step ST21 is repeated. If measurement of all the rooms has been completed, the operation of configuring the image database is finished. In this case, since measurement of room 2 has not yet performed, “NO” is obtained in step ST28, and a color image and distance information are acquired at each location as indicated by a dotted line 113 in FIG. 12 to perform the processing of steps ST21 to ST27.

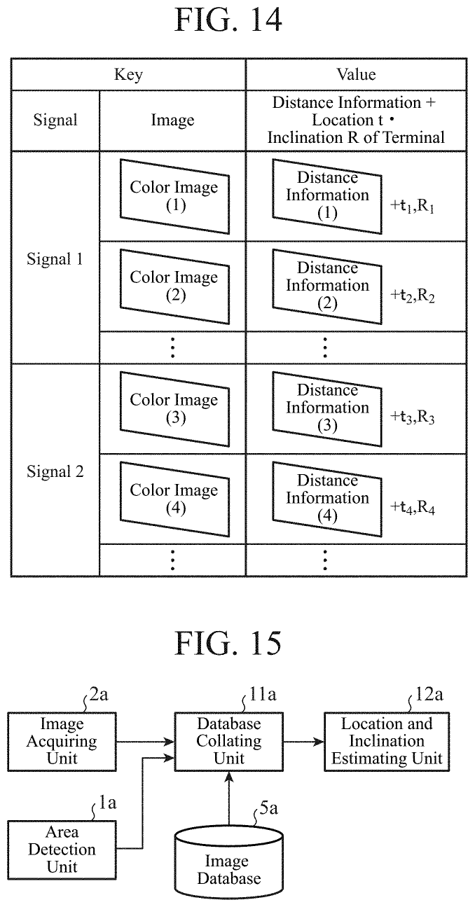

When measurement is performed for room 1 and room 2 by such a method and the image database generating unit 4a creates a database from the measurement results, an image database illustrated in FIG. 14 is generated (image database generating step). As illustrated in FIG. 14, pairs of an image, distance information/the location and inclination are registered for each signal. In this example, signal 1 and signal 2 are signals corresponding to room 1 and room 2 illustrated in FIG. 12; however, they may not necessarily correspond to the rooms depending on the size of the rooms or the number of the access points 107. For example, when a room is large and there are many access points 107, a plurality of groups may be formed in one room.

Next, a location and inclination estimation device of the second embodiment will be described.

FIG. 15 is a configuration diagram of a location and inclination estimation device. The location and inclination estimation device of the present embodiment includes an area detection unit 1a, an image acquiring unit 2a, a database collating unit 11a, a location and inclination estimating unit 12a, and an image database 5a. The image acquiring unit 2a and the area detection unit 1a are similar to the image acquiring unit 2a and the area detection unit 1a in the image database creation device. The database collating unit 11a is a processing unit for collating an image acquired by the image acquiring unit 2a with only images having the same signal value as a signal value detected by the area detection unit 1a out of images stored in the image database 5a and specifying one of the images. The location and inclination estimating unit 12a is a processing unit for outputting the location and inclination of the image specified by the database collating unit 11a as an estimation result. The image database 5a is a database generated by the image database creation device 100a.

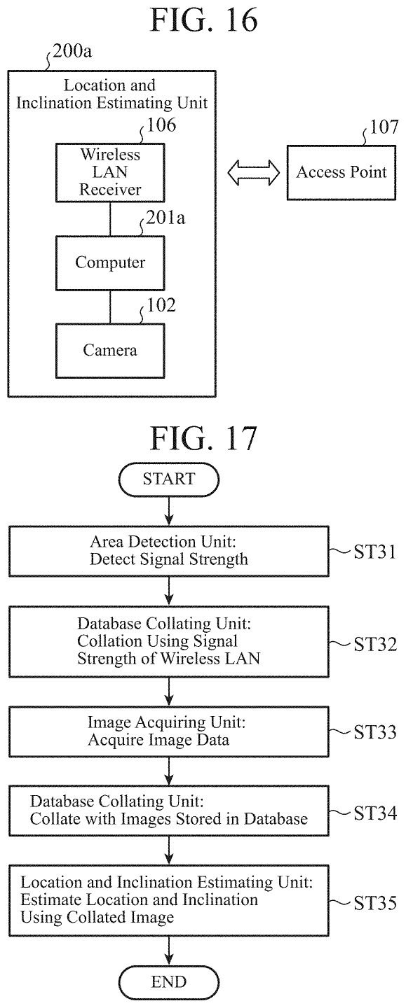

FIG. 16 is a hardware configuration diagram of the location and inclination estimation device illustrated in FIG. 7. In FIG. 16, a location and inclination estimation device 200a includes a wireless LAN receiver 106, a camera 102, and a computer 201a. The wireless LAN receiver 106 and the camera 102 are similar to the wireless LAN receiver 106 and the camera 102 of the image database creation device 100a illustrated in FIG. 11. The computer 201a is a device for acquiring data from the wireless LAN receiver 106 and the camera 102 and estimating the location and inclination of the terminal on the basis of these pieces of data, and includes, for example, a personal computer or a smartphone.

The wireless LAN receiver 106 in FIG. 16 implements the area detection unit 1a in FIG. 15, and the camera 102 implements the image acquiring unit 2a. The computer 201a implements the functions of the database collating unit 11a and the location and inclination estimating unit 12a. These functions are implemented by a processor of the computer 201a executing software corresponding to the database collating unit 11a and the location and inclination estimating unit 12a.

In a case where the location and inclination estimation device of FIG. 15 is configured as illustrated in FIG. 16, the image acquiring unit 2a to the location and inclination estimating unit 12a of FIG. 15 have the following functions. The image acquiring unit 2a acquires a color image photographed from the terminal location. The area detection unit 1a obtains the signal strength with each access point 107. The database collating unit 11a collates with the image database 5a on the basis of the color image acquired by the image acquiring unit 2a and the signal strength measured by the area detection unit 1 a, and the location and inclination estimating unit 12a outputs, as an estimation result, the location and inclination of an image as a collation result in the database collating unit 11.

Next, the operation of the location and inclination estimation device according to the second embodiment will be described with reference to a flowchart of FIG. 17.

When the area detection unit 1a detects signal strength from each access point at that location (step ST31), the database collating unit 13a first collates with the image database 5a on the basis of the signal strength (step ST32). When the image acquiring unit 2a acquires an image (step ST33), the database collating unit 13a collates the image from among the collation results of step ST32 (step ST34). That is, the database collating unit 13a first roughly estimates the location of the terminal on the basis of the signal strength from the area detection unit 1a and then collates with image data corresponding to the rough estimation result. For example, in the case of signal 1 in the collation in step ST32, collation is performed only with images of signal 1 among the image database 5a illustrated in FIG. 14. Then, from color images of signal 1, an image most similar to the image acquired in step ST33 is extracted. Next, the location and inclination estimating unit 14 estimates the location and inclination of the terminal on the basis of the distance information of the terminal+location t and inclination R of the terminal attached to the image extracted in step ST34 (step ST35).

In this manner, according to the location and inclination estimation device of the second embodiment, as a first effect, calculation time is reduced. In the present embodiment, the collation with the image database 5a is performed only on image data that corresponds to a specified signal. Therefore, the number of collated images can be reduced as compared with the related art. For example in the above example, the plurality of color images corresponding to signal 1 illustrated in FIG. 14 and an image acquired by the image acquiring unit 2a are collated. Since no collation is made with color images corresponding to signal 2, a reduction in calculation time is expected. As a second effect, discrimination of similar scenes is improved. For example, even in a case where room 1 and room 2 illustrated in FIG. 12 have the interior of similar patterns, the terminal location can be accurately estimated since preprocessing is performed in which the location of a user is roughly determined on the basis of the signal strength from each access point.

Note that, in the image database creation device and the location and inclination estimation device described above, the RSSI is used as the signal value detected by the area detection unit 1a; however, no limitation is intended to this, and any one of the signal strength of a beacon, the signal intensity of a ultra-wide band (UWB), the distance to an access point (time of flight (ToF)), and a measurement value of a geomagnetic sensor may be used.

As described above, according to the image database creation device of the second embodiment, the area detection unit measures set signal values at the plurality of locations as values corresponding to areas, the image database generating unit groups acquisition locations and inclinations of images calculated by the calculating unit using the signal values measured by the area detection unit, associates the signal values, the grouped acquisition locations and inclinations of the images, and the images as image information, and generates the image database by using the image information. Therefore, it is possible to provide the image database capable of improving the real-time property for estimation of location and inclination of an image and providing an accurate estimation result of the location and inclination.

Moreover, according to the image database creation device of the second embodiment, since the area detection unit measures any one of the RSSI, the signal strength of a beacon, the signal strength of a UWB, the distance to an access point, and a measurement value of a geomagnetic sensor as a set signal value, an area can be identified easily and reliably without requiring a special device for signal measurement.

Furthermore, according to the location and inclination estimation device of the second embodiment, the area detection unit measures set signal values at the plurality of locations as values corresponding to areas, the image database are grouped using the signal values, and the database collating unit collates with only images having the same signal value as the signal value detected by the area detection unit out of the images stored in the image database. Therefore, it is possible to improve the real-time property and to obtain an accurate estimation result of the location and inclination.

Moreover, according to the location and inclination estimation device of the second embodiment, since the area detection unit measures any one of the RSSI, the signal strength of a beacon, the signal strength of a UWB, the distance to an access point, and a measurement value of a geomagnetic sensor as a set signal value, an area can be identified easily and reliably without requiring a special device for signal measurement.

Note that, within the scope of the present invention, the present invention may include a flexible combination of the respective embodiments, a modification of any component of the respective embodiments, or an omission of any component in the respective embodiments.

### INDUSTRIAL APPLICABILITY

As described above, an image database creation device, a location and inclination estimation device, and an image database creation method according to the present invention relate to a configuration for obtaining the location and inclination of a terminal using images registered in advance, and are suitable for use in an application that displays additional information superimposed on a specific object.

### REFERENCE SIGNS LIST

1, 1a: Area detection unit, 2: Sensor information acquiring unit, 2a: Image acquiring unit, 2b: Distance measuring unit, 3: Locational relationship calculating unit, 4, 4a: Image database generating unit, 5, 5a: Image database, 6: Signal measuring unit, 11, 11a: Database collating unit, 12, 12a: Location and inclination estimating unit, 1, 100, 100a: Image database creation device, 101: RFID receiver, 102: Camera, 103: Distance sensor, 104, 104a, 201, 201a: Computer, 105: RFID tag, 106: Wireless LAN receiver, 107: Access point, 200, 200a: Location and inclination estimation device.

1. An image database creation device comprising:
a processor; and
a memory storing instructions, upon executed by the processor, causing the processor to perform a process of:
detecting which area out of a plurality of areas a photographed image belongs to;
acquiring distance information indicating a distance between a photographed object of the photographed image and an acquisition location of the photographed image;
calculating a photographing location and an inclination of the photographed image on a basis of the distance information; and
generating an image database in which the photographing location and the inclination of the photographed image and the photographed image are associated as image information, the process generating the image database by grouping image information of images belonging to a same area.

2. The image database creation device according to claim 1, wherein the plurality of areas is associated with the area detected by the process in a one-on-one manner.

3. The image database creation device according to claim 2, wherein the process detects the area using radio frequency identification (RFID).

4. The image database creation device according to claim 1,
wherein the process measures a set signal value at a plurality of locations as a value corresponding to the area, and
the process groups the acquisition location and the inclination of the image calculated by the process using the signal value measured by the process, associates the signal value, the grouped acquisition location and the inclination of the image, and the image as image information, and generates the image information as an image database.

5. The image database creation device according to claim 4,
wherein the process measures any one of a received signal strength indicator (RSSI), signal strength of a beacon, signal strength of an ultra-wide band (UWB), a distance to an access point, and a measurement value of a geomagnetic sensor as the set signal value.

6. A location and inclination estimation device comprising:
a processor; and
a memory storing instructions, upon executed by the processor, causing the processor to perform a process of:
storing image information in which images having information of a photographing location and an inclination are grouped by a plurality of areas;
detecting which area out of the plurality of areas an image belongs to;
acquiring an image of a photographed object;
collating the image acquired by the process with only an image belonging to a same area detected by the process out of images stored in the image database; and
outputting, as an estimation result, a location and an inclination of an image as a collation result in the process.

7. The location and inclination estimation device according to claim 6, wherein the plurality of areas is associated with the area detected by the process in a one-on-one manner.

8. The location and inclination estimation device according to claim 6, wherein the process detects the area using RFID.

9. The location and inclination estimation device according to claim 6, wherein the process measures a set signal value at a plurality of locations as a value corresponding to the area,
the image database is grouped using the signal value, and
the process collates with only an image having a same signal value as the signal value detected by the process out of the images stored in the image database.

10. The location and inclination estimation device according to claim 9, wherein the process measures any one of an RSSI, signal strength of a beacon, signal strength of a UWB, a distance to an access point, and a measurement value of a geomagnetic sensor as the set signal value.

11. An image database creation method using the image database creation device according to claim 1, the method comprising:
detecting which area out of a plurality of areas a photographed image belongs to;
acquiring distance information indicating a distance between a photographed object of the photographed image and an acquisition location of the photographed image;
calculating a photographing location and an inclination of the photographed image on a basis of the distance information; and
generating an image database in which the photographing location and the inclination of the photographed image and the photographed image are associated as image information, the image database generated by grouping of image information of images belonging to a same area.
